(19) United States
(12) Patent Application Publication
(10) Pub. No.: US 2009/0042443 A1
(43) Pub. Date: Feb. 12, 2009

(54) Method for assembling an electrical connector to a metal shell

(75) Inventor: Wen-Qiang Ma, Santa Clara, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO.,LTD.

(21) Appl. No.: 12/228,023

(22) Filed: Aug. 8, 2008

(30) Foreign Application Priority Data
Aug. 8, 2007 (CN) 2007 10025891.6

(51) Int. Cl. H01R 13/648; H01R 43/16

(52) U.S. Cl. 439/607; 29/874

(57) ABSTRACT

A method for assembling a terminal insert onto a metallic housing comprises the steps of: (1) providing a terminal insert defining a dowel post extending out of the surface thereof; (2) providing a metallic housing having a hole corresponding with the dowel post; (3) assembling the terminal insert on the metallic housing by aligning the dowel post with respect to the hole; (4) inserting the dowel post into the hole and then deforming a portion of the dowel post by applying adequate heat.

### BACKGROUND OF THE INVENTION

1. Field of the Invention

The present invention relates to a method, and more particularly to a method for assembling an insert-molded connector to a metal shell through inserting a dowel post of the insulating housing into an opening of the metal shell and then deforming a portion of the dowel post by applying adequate heating.

2. Description of the Related Art

Conventionally, electronic modules such as a camera module for use with a cellular phone are securely maintained in electrical connection with an electronic member such as a printed circuit board. Therefore, a camera socket is dimensioned to securely position a camera module therein. Consequently, the camera module is electrically connected with the printed circuit board via the electrical connector.

Commonly, an electrical connector suited for electrical connecting a camera module to a printed circuit board comprises many elements and the relative position of the elements is important to the electrical path between the camera module and the printed circuit board.

US. Public Patent No. 2008-32553, discloses an electrical connector for connecting to the printed circuit board via a plurality of terminal contacts. Said electrical connector includes a lower shield, a pair of terminal inserts, and a pair of top shields. Wherein the lower shield comprises bottom wall and four side walls extending upwardly and said bottom wall and the side walls forms a receive space opened to the top end. The terminal inserts assemble on an opposite side walls and each comprises a plurality of terminal contacts and an insulative housing for holding the terminal contacts. The top shields assembled on an opposite side walls and covers the terminal contacts. In order to retain the lower shield, the terminal inserts, and the top shields, each insulating housing defines a pair of first holes and a second holes and said first and second holes arranges adjacent to each other, and the lower shield defines a pair of first stabs extending to the receiving space and corresponding to the first holes and the top shield defines a pair of second stabs for engaging with the second holes. In a result, when assembly, firstly, the terminal inserts assembled on the side walls with the first stabs engaged with the first holes, then the top shields covered on the terminal inserts and the second stabs engaged with the second holes. Thus, said lower shield, top shield, and the terminal inserts are hold together via the stabs engaging with the holes.

Another U.S. patent applicant Ser. No. 12/009,012, discloses an electrical connector, which structure is nearly same to said electrical connector, which public No. is 2008-32553. The difference between them is that a plurality of holes stead of the stabs formed on the lower and top shield, meanwhile, the electrical connector further comprises a plurality of fastening sticks. When assembly, the fastening sticks penetrate the holes formed on the lower and top shield in turn, thereby the lower shield, the top shield, and the terminal inserts are assembled together by the engagement of the holes and the fastening sticks.

### BRIEF SUMMARY OF THE INVENTION

It is an object of the present invention to provide a method for assembling an insulating element and a metal element together by hot melt so as to make the insulating element and the metal element engaging firmly.

In order to achieve the objective above, a method for assembling an insulating element and metal element in accordance with a preferred embodiment of the present invention is provide. The method includes following steps: (1) provide an insulating element with at least a post which extrudes the surface of the insulating element; (2) provide a metal element with at least a hole corresponding to the post of the insulating element; (3) assemble the insulating element and the metal element together with the post penetrating the holes; (4) hot melt the post extruding the surface of the insulating element and the melted post entered into the clearance between the hole and the post. According to said method, the insulating element and the metal element engaged firmly.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like members in the figures and in which:

FIG. 1 is a perspective view of an electrical connector according to the embodiment of the present invention;

FIG. 2 is a front view of the electrical connector of FIG. 1;

FIG. 3 is a left view of the electrical connector of FIG. 1;

FIG. 4 is an exploded view of the electrical connector according to the present invention;

FIG. 5 is another exploded view of the electrical connector according to the present invention, wherein the insulating sheet has attached to the lower shield and the insulating housing and the terminal contacts has assembled together;

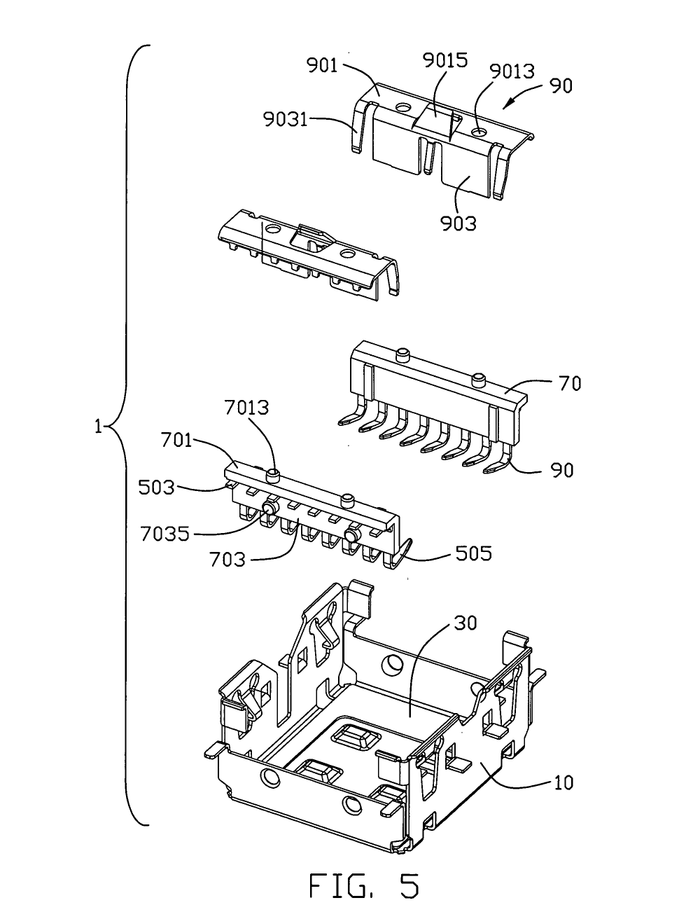

FIG. 6 is a perspective view of the lower shield according to the present invention;

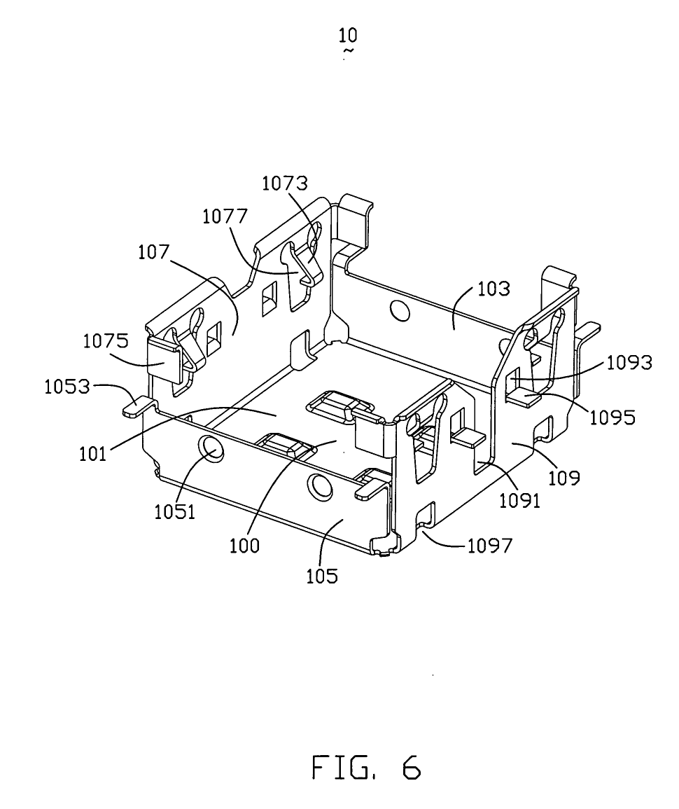

FIG. 7 is an assembly flow chart of present invention of FIG. 1;

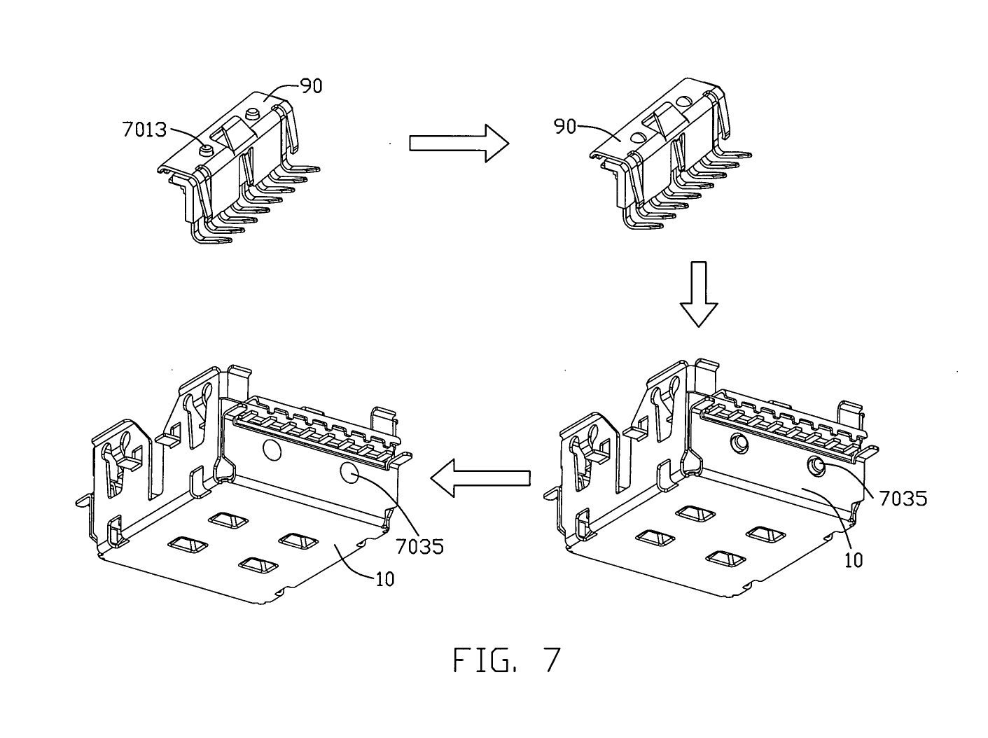

FIG. 8 is a section view of the present invention, wherein the heating is not applied on the dowel post.

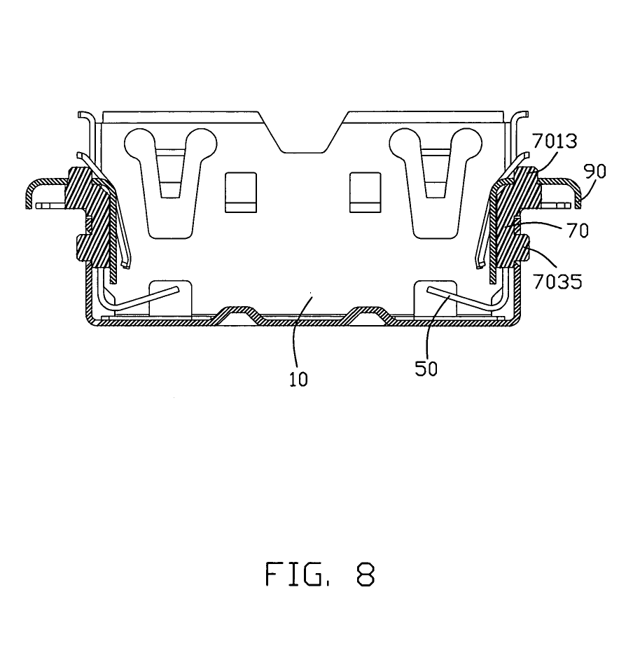

FIG. 9 is a section view of the present invention, wherein the heating is already applied on the dowel post.

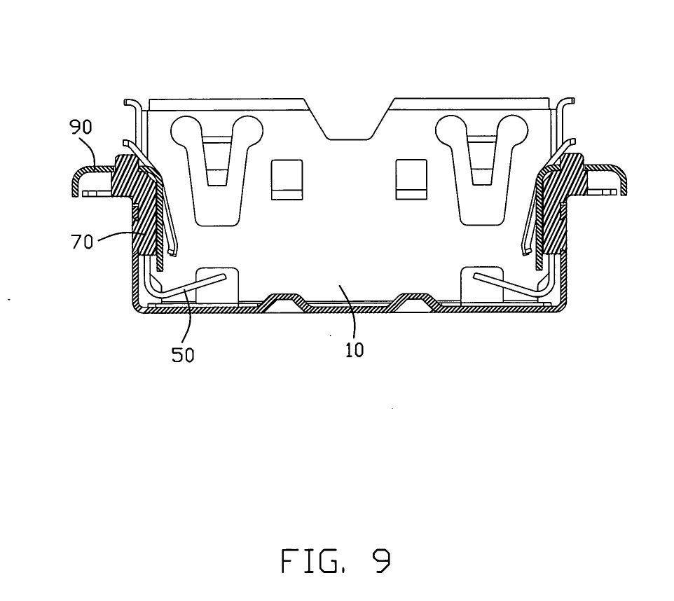

### DESCRIPTION OF PREFERRED EMBODIMENT OF THE INVENTION

In the following detailed description, for purposes of explanation, numerous specific details are set forth in order to provide a thorough understanding of the present invention.

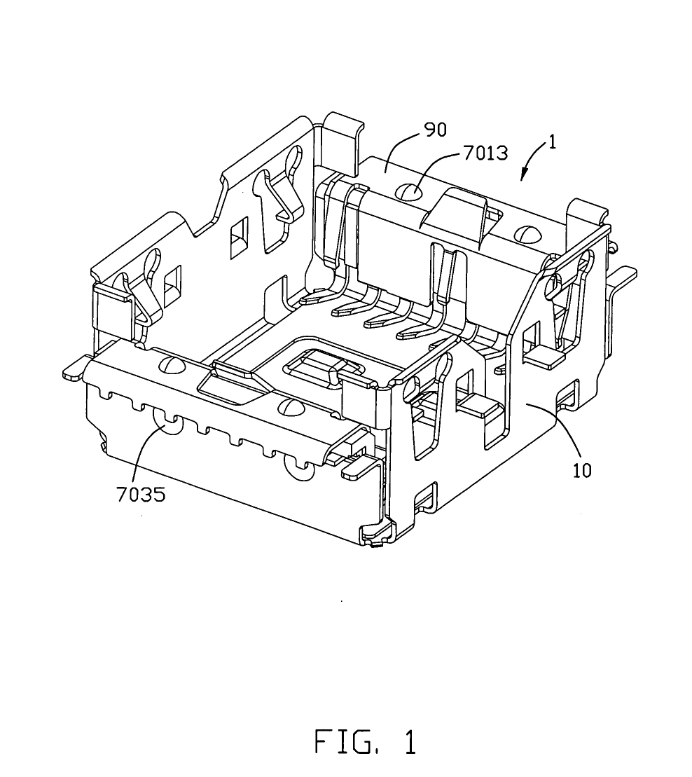

An electrical connector according to the present invention is applicable to an electronic apparatus such as digital cameras, PDAs (Personal Digital Assistants), PCs (Personal Computers), mobile phones or the like. In the preferred embodiment illustrated in FIGS. 1-4, the electrical connector is used in a mobile handset (not shown) for transferring the signal of the camera module to a printed circuit board.

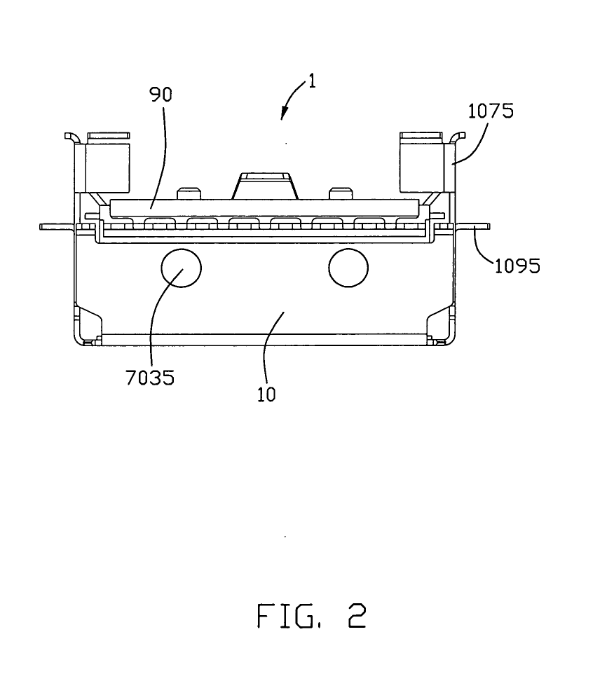

FIG. 2 is an exploded view of the electrical connector according to the embodiment of this invention in order to receive a camera module. In the figures, the reference numeral 10 denotes a lower shield made of a metal material. The reference numeral 30 denotes an insulating sheet, the reference numeral 50 denotes a terminal contact, the reference numeral 70 denotes an insulating housing, and the reference numeral 90 denotes a top shield.

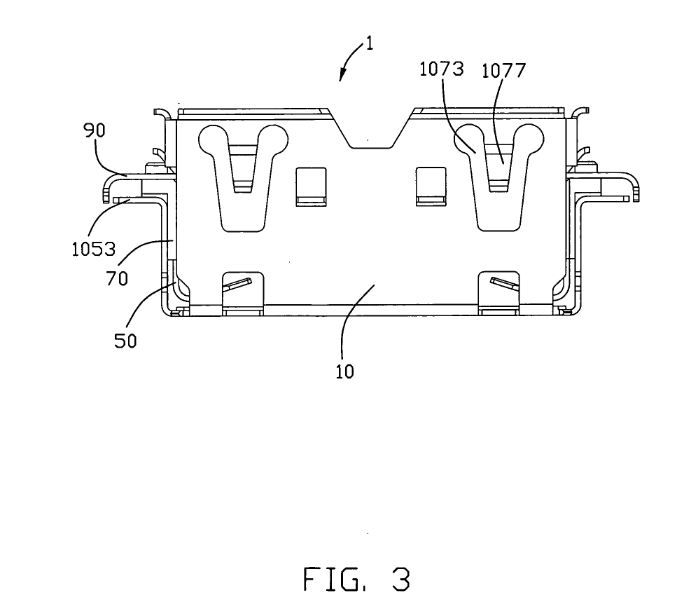

Please refer to FIG. 3, the lower shield 10 is made of metal material and configured by a first wall 103, a second wall 105, a third wall 107, a fourth wall 109 and a base wall 101 cooperatively defining a receiving space 100. Wherein, the height of the first and second walls is lower than that of the third and fourth walls. Each first wall 103, second wall 105, third wall 107 and fourth wall 109 extends upwardly from the peripheral of the base wall 101 and the adjacent walls of the said walls did not connect each other and a connecting area of each of the first, second, third, and fourth wall 103, 105, 107, 109, and the base wall 101 forms a gap 1097 so as to improve the elastic property of the lower shield 10 and retain the camera module (not shown) better firmly.

The first and second walls 103, 105, have a same structure, each defines a pair of first holes 1051 penetrate therebetween and arranges as one row, and a pair of tail tabs 1053 are formed on the top side ends thereof and extend toward outside for connecting with the printed circuit board (not shown).

Each of the third and fourth walls 107, 109, defines a pair of V-shaped openings 1077 and a locking finger 1073 is formed in each V-shaped opening 1077 and extends downwardly from the top edge thereof to the opposite wall, and the end of the locking fingers 1077 cured back to avoid scrapping the camera module. Between the positions of the locking fingers 1073, a pair of rectangular openings 1093 is formed and each rectangular opening 1093 defines a tail tab 1095. Said tail tabs 1053, 1095, and the terminal contact are together adapted for connecting with the printed circuit board. Additionally, in order to hold the camera module better, a pair of hold skirts 1075 is formed on the two side edges of the third and fourth walls, and the hold skirts 1075 and the third/fourth wall 107, 109, forms an encircled shape, thereby to better hold the camera module. Besides, a widow 1091 is formed between the rectangular openings 1093 and extends from the top end of the fourth wall 109 to bottom end thereof. Said window 1091 forms a V-shape, that is to say that the dimension of upper end of the window 1091 is larger than that of bottom end.

Please refer to FIG. 2, the insulating sheet 30 is provided with an insulating material and located against with the base wall 101 of the lower shield 10 so as to prevent the terminal contacts 50 contacting with the lower shield 10 and avoid a short circuit happening. Said insulating sheet 30 is a rectangular shape, a rectangular window (not labeled) is provided in the center thereof.

Please still refer to FIG. 2, a pair of terminal inserts is separately located on the first and second walls 103, 105, each comprising a plurality of terminal contacts 50 and an insulating housing 70 to hold the terminal contacts 50. Each of the terminal contacts 50 includes an upright portion 501, a tail portion 503 extending horizontally from the top end of the upright portion 501 to outside for connecting with the printed circuit board, and contact engaging portion 505 extending from lower end of the upright portion to the opposite wall. Wherein said upright portion 501 extends along the inserting direction of the camera module. Each of the insulating housings 70 forms an L-shape and comprises an upright section 703 extending along a first direction and a horizontal section 703 extending along a second direction vertical to the first direction. Wherein the upright section 703 includes a mating surface 7031 against with the inner surface of one of the first and second walls 103, 105 and an unmating surface 7033 opposite to the mating surface 7031, a pair of first posts 7035 is formed on the mating surface 7031 of the upright section 703 corresponding to the first holes 1051 of the lower shield 10. Meanwhile the horizontal section 701 includes an upper surface 7011 and a bottom surface (not labeled) opposite to the upper surface 7011, and a pair of second posts 7013 is formed on the upper surface 7011 corresponding to the first posts 7035.

Each of the top shields 90 has a same structure with the insulating housing 70 and comprises board section 901 extending along the second direction and a side section 903 extending along the first direction. The free end of the board section 901 defines a plurality soldering pads 9011 adapted for connecting with the printed circuit board and a pair of second holes 9013 penetrating therebetween and corresponding to the second posts 7013 of the insulating housing 70. The intersect area between the board section 901 and the side section 903 defines a leading portion 9015 extending upwardly and slantly and a plurality of against portion extending downwardly and slantly.

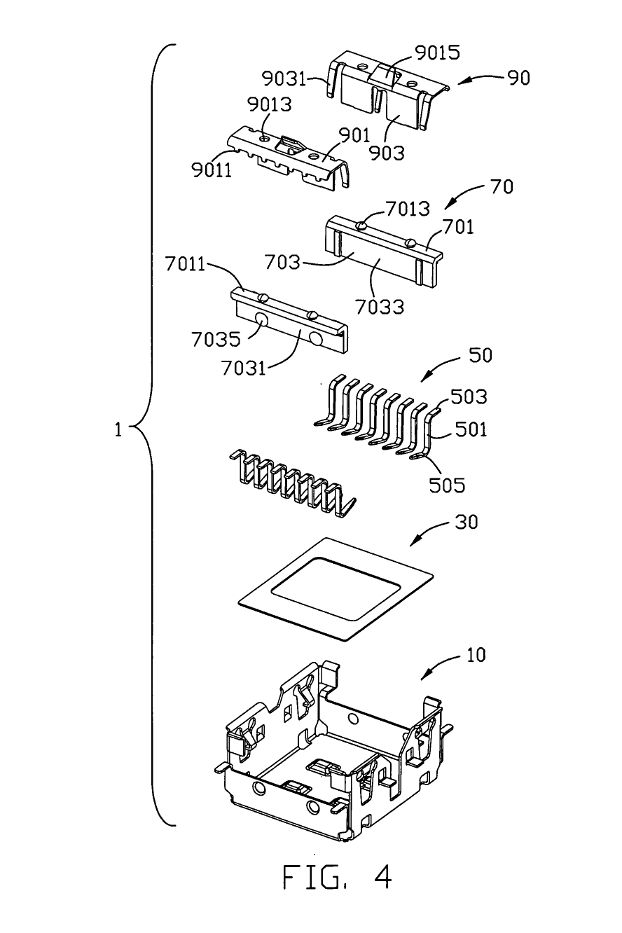

Please refer to the FIG. 4 and combined FIGS. 1-3, when assembly, it includes following steps: (1) the insulating sheet 30 is positioned on the base wall 101 of the lower shield 10; (2) the terminal contact 50 is assembled into the insulating housing 70, wherein the contact engaging portions 505 is being in the receiving space 100 and the tail portion 503 extends outside; (3) the top shields 90 straddled on the terminal inserts, wherein the second posts 7013 penetrating the corresponding second hole; (4) partly hot up and make the second posts 7013 extruded outside melt and come into the gap formed between the second posts 7013 and corresponding second holes 9013 so as to make the terminal inserts and the corresponding top shields 90 integrate together; (5) separately put the terminal inserts and the top shields 90 on the first and second walls 103, 105, of the lower shield 10, wherein the first posts 7035 of the insulating housing 10 penetrate into the corresponding first holes 1051 of the lower shield 10; (6) partly hot up and make the first posts 7035 extruded outside melt and come into the gap between the first holes 1051 and corresponding first posts 7035.

In the above description of the preferred embodiment, the insulating housing and the metal element including top and lower shields are assembled together by hot melt, thereby during using of consumers, especially during the process of mobile phone falling, it is impossible happening that the insulating housing and the metal element is falling up. Additionally, when the electrical connector of present invention is connected with the printed circuit board, it can passes through a hole formed on the printed circuit board. Thus, the out surface of the lower shield must be smooth. In other words, during the process of hotting up, the first posts extruded outside must completely come into the gap formed between the first holes and corresponding first posts. As for the second posts, it is not required that it completely come into the gap formed the second holes and corresponding first posts.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A method for assembling a terminal insert onto a metallic housing, comprising the steps of:
a) providing a terminal insert having at least a dowel post;
b) providing a metallic housing defining an opening at a wall thereof corresponding the dowel post;
c) attaching the terminal insert onto the metallic housing by aligning the dowel post with respect to the opening; and
d) inserting the dowel post into the opening and then deforming a portion of the dowel post by applying adequate heat.

2. The method as recited in claim 1, wherein the post is completely received into the opening after applying adequate heat.

3. The method as recited in claim 1, wherein the method further comprising a step between step (b) and step (a):
e) providing a shielded shell having a second opening;
f) attaching the shielded shell onto the terminal insert by aligning a second dowel post with respect to the second opening;

4. An electrical connector comprising:
a shielded shell;
a terminal insert assembled with the shielded shell and the terminal insert comprising a plurality of terminal contacts and an insulating housing holding the terminal contacts, each terminal contact including an upright portion, a contact engaging portion, and a tail portion;
the insulating housing defining a post extending out of surface thereof and the shielded shell defining a corresponding hole engaging with the post, and the insulating housing and the shielded shell being retained together by applying a heating on the post and putting the smelted post coming into a gap formed between the post and hole.

5. The electrical connector as recited in claim 4, wherein the diameter of the hole is not accordant.

6. The electrical connector as recited in claim 5, wherein the diameter of the hole from the inner wall to outer wall is more and more larger.

7. The electrical connector as recited in claim 6, wherein after applying heating on the dowel post, the melted dowel post complete come into the hole from the outer surface thereof.

8. The electrical connector as recited in claim 4, wherein the shielded shell comprises a bottom wall, a first wall, a second wall, a third wall, and a forth wall, and the height of the opposite first and second is lower than that of the opposite third and forth wall, said terminal insert assembled on the first and second wall.

9. The electrical connector as recited in claim 8, wherein at least a tail tab is formed on each of the first and second wall, and the hole is disposed under the tail tab.

10. The electrical connector as recited in claim 9, wherein the insulating housing comprises a horizontal section and a vertical section, said post is defined on the vertical section.

11. The electrical connector as recited in claim 9, wherein the tail portion of the terminal contact extends from the top end of one of the first and second wall of the shielded shell to outside and the tail portion of the terminal contact disposed on a same height with the tail tab.

12. The electrical connector as recited in claim 9, wherein each of third and forth wall of the shielded shell defines a pair of skirts formed on the two side ends thereof.

13. The electrical connector as recited in claim 12, wherein the pair of skirts and each of the third and forth forms an encircled shape and the skirt disposed above the terminal insert.

14. The electrical connector according to claim 9, further comprising an insulating sheet attached to the bottom wall of the shielded shell.

15. The electrical connector according to claim 14, wherein each of the contact engaging portion of the terminal contact disposed above the insulating sheet for prevent the contact engaging portion contacting with the bottom wall.

16. An electrical connector comprising:
a terminal insert including an insulator with a plurality of terminals embedded therein with contacting sections and mounting sections extending on two opposite sides;
said insulator being of an L-shaped configuration with an upper horizontal plate and a vertical plate, a first post formed on an upper face of the upper horizontal plate and a second post formed on an outer face of the vertical plate; and
a top shield positioned upon the terminal insert and including a horizontal wall which is seated upon the upper horizontal plate and is equipped with a first through hole under a condition that said first post extends through said first through hole and is deformed to be snugly and retainably engaged therein;
a bottom shield defining a camera socket receiving cavity therein and including a vertical wall having a second through hole therein under a condition that said second post extends through said second through hole and is deformed to be snugly and retainably engaged within.

17. The electrical connector as claimed in claim 16, wherein a tip of said second post does not extend beyond an outer face of the vertical wall.

18. The electrical connector as claimed in claim 16, wherein the mounting sections of the terminals is located under the first post and facing downward.
